(19) United States
(12) Patent Application Publication
(10) Pub. No.: US 2002/0071287 A1
(43) Pub. Date: Jun. 13, 2002

(54) Laser pointer with multiple color beams

(75) Inventor: Michael Albert Haase, Saint Paul, MN (US)

Correspondence Address: Attention: Philip Y. Dahl, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/736,117

(22) Filed: Dec. 13, 2000

(51) Int. Cl. F21K 2/00; G01S 1/00

(52) U.S. Cl. 362/553; 372/92; 362/259; D26/37

(57) ABSTRACT

A laser pointer is provided having multiple laser elements emitting collimated visible light beams at multiple wavelengths.

### FIELD OF THE INVENTION

This invention relates to a laser pointer having multiple laser diode elements emitting collimated visible light beams at multiple wavelengths.

### BACKGROUND OF THE INVENTION

Gas lasers have been well known for many decades. It is well known that gas lasers are heavier and larger than semiconductor laser diodes. They require much higher supply voltages than semiconductor laser diodes, and therefore require more ancillary equipment. As a result, it is recognized that gas lasers are less suitable for hand-held devices.

The present inventor appears on numerous US patents concerning blue-green laser diodes, including U.S. Pat. Nos. 5,213,998, 5,274,269, 5,291,507, 5,319,219, 5,395,791, 5,396,103, 5,404,027, 5,513,199, 5,538,918, 5,767,534, 5,767,534, 5,818,859, 5,834,330, 5,879,962, 5,963,573, 5,974,070, 6,057,559, 6,058,123, and 6,090,637. Some of these references disclose a laser pointer having a blue-green laser diode element.

Laser pointers are well known and widely available. Laser pointers are used to draw the attention of an audience to a particular feature of a visual aid, typically a projected image. They are preferably small, easy to hold and easy to transport.

Most commercially available laser pointers have a red beam, typically generated by a He—Ne gas laser or III-V (e.g., AlGaInP-based) semiconductor diode laser. Green laser pointers are also available, where the beam is generated by a frequency-doubled diode-pumped YAG (yttrium-aluminum-garnet) laser. The frequency doubled YAG laser pointers are relatively expensive due to the complexity of the system. In addition, they require more frequent battery replacement due to the inefficient light generating mechanism.

### SUMMARY OF THE INVENTION

The present invention provides an electronic device having multiple laser elements capable of emitting collimated beams of visible light at different frequencies. Preferably, the laser elements emit collimated beams which are substantially parallel. Preferably, the device includes a red-emitting laser diode and a green- or blue-emitting laser diode. Preferably the laser elements may be independently actuated by the user.

What has not been described in the art, and is provided by the present invention, is a laser pointer having multiple color beams resulting in greater expressive capability and the ability to function effectively on projection surfaces of different colors and shades.

It is an advantage of the present invention to provide a laser pointer having greater expressive capability and therefore greater performance as a tool of communication. As an example, contrasting pointer spots may be used to better indicate and emphasize opposing concepts: profit vs. loss, advantage vs. disadvantage, plaintiff's case vs. defendant's case, etc.

It is a further advantage of the present invention to provide a laser pointer having improved contrast on projection surfaces of different colors. Contrasting background colors may be unavoidable or may be deliberately introduced for expressive impact. With the present invention, a red laser may be used on a green background and a green laser on a red background to improve the ability of the audience to see the laser spot used for pointing.

### BRIEF DESCRIPTION OF THE DRAWING

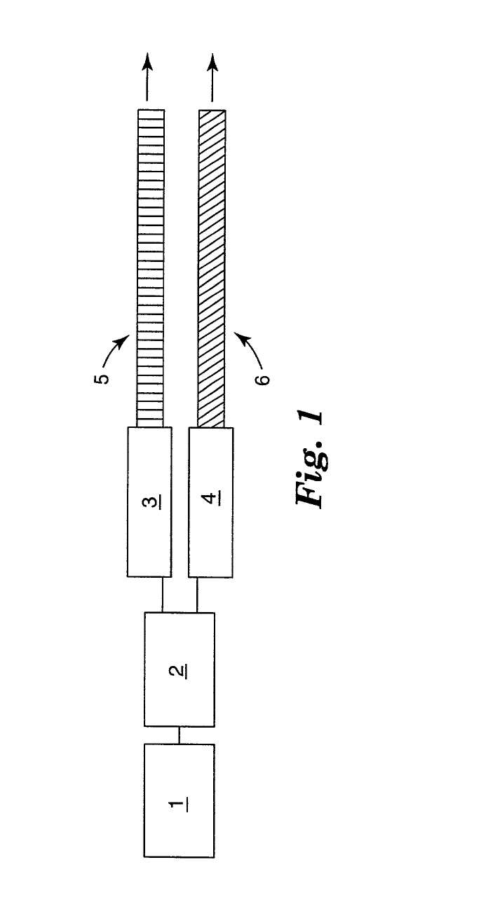

The invention will be further described in reference to FIG. 1, which is a schematic depiction of a pointer according to the present invention. Red (vertical hatching) and green (diagonal hatching) beams are depicted.

### DETAILED DESCRIPTION OF PREFERRED EMBODIMENTS

The present invention provides an electronic device having a plurality of laser elements capable of emitting beams of visible light, at least two of the laser elements emitting light at different frequencies. Preferably the beams collimated and are substantially parallel. Preferably, the device comprises a red-emitting laser diode and a green- or blue-emitting laser diode. Additional laser elements may be included to provide additional colors.

A preferred embodiment, depicted schematically in FIG. 1, includes a red laser diode (3) capable of producing a red laser beam (5), a green laser diode (4) capable of producing a green laser beam (6), a battery (1), and an electrical switching circuit (2) capable of supplying power to the red laser diode or the green laser diode. Preferably beams (5) and (6) are collimated and are substantially parallel and the device weighs no more than 450 grams.

At least two of the laser elements emit light at different wavelengths. Preferably the different wavelengths provide strong visual contrast, preferably with one being in the red, orange or yellow range of visible wavelengths and another being in the green, blue or violet range of visible wavelengths. Preferably one laser element emits light in a red wavelength and another laser element emits light in a green or blue wavelength. One preferred embodiment comprises a green-emitting II-VI semiconductor laser diode element, especially a CdZnSe-based laser diode element such as taught in U.S. Pat. Nos. 5,213,998, 5,274,269, 5,291,507, 5,396,103, 5,404,027, 5,513,199, 5,538,918, 5,767,534, 5,818,859, 5,963,573, 5,974,070, 6,057,559, and 6,090,637, and a red-emitting III-V semiconductor laser diode element, such as the AlGaInP-based laser diode element such as commonly used in laser pointers widely marketed today.

The device is advantageously provided with appropriate optics for collimating the laser beams. The collimated light beams of the laser elements preferably are substantially parallel; i.e. the angle between the light beams is preferably no more than 5°. More preferably the angle between the light beams is no more than 3°, more preferably no more than 1°, more preferably no more than 0.5° and most preferably no more than 0.1°. As referred to herein, angles between light beams are angles between a central axis of each beam.

The laser elements are preferably mounted close together, preferably as close as practically possible. Preferably the orthogonal distance between the beams at the source of one beam is less than 10 mm, more preferably less than 5 mm, more preferably less than 2 mm, and most preferably less than 1 mm.

The device is advantageously provided with at least one power source such as a battery to power the lasers. The device is advantageously provided with switches or power regulating circuits allowing the user to actuate at least two of the lasers independently. Preferably, the switches or power regulating circuits are configured so that total output power from the pointer cannot exceed a fixed limit, which should be at or below any safety of regulatory limits. In one embodiment, this is accomplished by preventing more than one laser element from operating at a given time. This result may be accomplished by a circuit with an electronic lockout or by the use of a switch that can actuate only one laser at a time, e.g., a two-position center-off switch. This solution also reduces the need to precisely align the laser beams to point at the same spot, since the lack of alignment will not be revealed by simultaneous use of the lasers. The switches or power regulating circuits may allow the user to periodically flash any one laser or alternately flash two or more lasers. The switches or power regulating circuits may allow the user to dim the power output of a laser.

The device may be equipped with an indicator such as a light emitting diode to indicate available battery power or otherwise signal that a battery needs replacement. The device may also be equipped with indicator(s) to indicate to the user that a laser is on, and optionally the color of the beam. This can be realized with LEDs of by use of an optical system which redirects stray light from the laser toward the user, such as a clear plastic ring around the beam aperture.

In addition to optics for collimating the laser beams, optics such as lenses or diffractive optics may be provided. The additional optics may be used to create beams of different shapes or project images such as lines, circles or arrows. Preferably these optics are easily moved and removed to and from the beam so the user can conveniently change beam shape as well as color.

The device according to the present invention is advantageously a hand-held device, preferably no more than 450 grams in weight including appropriate batteries, more preferably no more than 300 grams, more preferably no more than 200 grams, and most preferably no more than 100 grams.

This invention is useful as a pointer to aid in visual presentation of information. It is contemplated that the pointer according to the present invention may also be useful in targeting systems, weapons sights, tool alignment systems, surveying equipment, and other electronic systems or equipment wherein a laser provides a visible indicator. The ability of the device according to the present invention to provide a beam to contrast the color of any background surface is an advantage in such applications.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

We claim:

1. An electronic device comprising a plurality of laser elements capable of emitting beams of visible light, at least two of said laser elements emitting light at different frequencies, additionally comprising a battery and a electrical switching circuit, wherein said device weighs no more than 450 grams.

2. An electronic device comprising a plurality of laser elements capable of emitting beams of visible light, at least two of said laser elements emitting light at different frequencies, wherein at least one of said laser elements is a laser diode.

3. An electronic device comprising a plurality of laser diodes capable of emitting beams of visible light, at least two of said laser diodes emitting light at different frequencies.

4. The electronic device according to claim 1 wherein no more than one laser element may be actuated at any one time.

5. The electronic device according to claim 2 wherein no more than one laser element may be actuated at any one time.

6. The electronic device according to claim 3 wherein no more than one laser diode may be actuated at any one time.

7. The electronic device according to claim 1 wherein said at least two laser elements emit beams which are collimated beams which are substantially parallel.

8. The electronic device according to claim 2 wherein said at least two laser elements emit beams which are collimated beams which are substantially parallel.

9. The electronic device according to claim 3 wherein said at least two laser diodes em it beams which are collimated beams which are substantially parallel.

10. The electronic device according to claim 1 wherein at least one of said laser elements emits light at a red, orange or yellow visible wavelength and at least one of said laser elements emits light at a green, blue or violet visible wavelength.

11. The electronic device according to claim 2 wherein at least one of said laser elements emits light at a red, orange or yellow visible wavelength and at least one of said laser elements emits light at a green, blue or violet visible wavelength.

12. The electronic device according to claim 3 wherein at least one of said laser diodes emits light at a red, orange or yellow visible wavelength and at least one of said laser diodes emits light at a green, blue or violet visible wavelength.

13. The electronic device according to claim 1 wherein at least one of said laser elements emits light at a red visible wavelength and at least one of said laser elements emits light at a green or blue visible wavelength.

14. The electronic device according to claim 2 wherein at least one of said laser elements emits light at a red visible wavelength and at least one of said laser elements emits light at a green or blue visible wavelength.

15. The electronic device according to claim 3 wherein at least one of said laser diodes emits light at a red visible wavelength and at least one of said laser diodes emits light at a green or blue visible wavelength.

16. The electronic device according to claim 1 wherein at least one of said laser elements is a green-emitting II-VI semiconductor laser diode and at least one of said laser elements is a red-emitting III-V semiconductor laser diode.

17. The electronic device according to claim 2 wherein at least one of said laser elements is a green-emitting II-VI semiconductor laser diode and at least one of said laser elements is a red-emitting III-V semiconductor laser diode.

18. The electronic device according to claim 3 wherein at least one of said laser diodes is a green-emitting II-VI semiconductor laser diode and at least one of said laser diodes is a red-emitting III-V semiconductor laser diode.

19. The electronic device according to claim 6 wherein at least one of said laser diodes is a green-emitting II-VI semiconductor laser diode and at least one of said laser diodes is a red-emitting III-V semiconductor laser diode.

20. The electronic device according to claim 1 wherein at least one of said laser elements comprises a green-emitting frequency-doubled laser and at least one of said laser elements comprises a red-emitting III-V semiconductor laser diode.

21. The electronic device according to claim 2 wherein at least one of said laser elements comprises a green-emitting frequency-doubled laser and at least one of said laser elements comprises a red-emitting III-V semiconductor laser diode.

22. The electronic device according to claim 2 additionally comprising a battery and a electrical switching circuit, said device weighing no more than 450 grams.

23. The electronic device according to claim 3 additionally comprising a battery and a electrical switching circuit, said device weighing no more than 450 grams.

24. The electronic device according to claim 20 additionally comprising a battery and a electrical switching circuit, said device weighing no more than 450 grams.
